(19) United States
(12) Patent Application Publication
(10) Pub. No.: US 2026/0040071 A1
(43) Pub. Date: Feb. 5, 2026

(54) TUNNEL ESTABLISHMENT FOR NON-SEAMLESS WLAN OFFLOADING

(71) Applicant: Lenovo (Singapore) Pte. Ltd., Singapore (SG)

(72) Inventors: Apostolis Salkintzis, Athens (GR); Genadi Velev, Darmstadt (DE)

(21) Appl. No.: 18/996,675

(22) PCT Filed: Sep. 12, 2022
(86) PCT No.: PCT/EP2022/075247

§ 371 Date: Jan. 17, 2025

(30) Foreign Application Priority Data
Jul. 19, 2022 (GR) 20220100574

(51) Int. Cl. H04W 12/06; H04W 28/08; H04W 84/12

(52) U.S. Cl. CPC H04W 12/068; H04W 28/08; H04W 84/12

(57) ABSTRACT

Apparatuses, methods, and systems are disclosed for tunnel establishment for Non-Seamless WLAN Offloading. One apparatus includes a processor coupled with a memory and configured to receive a first message indicating that a user equipment (UE) requests to connect to a WLAN AN and determine that the UE is authorized to connect to the WLAN AN. The processor is configured to determine, in response to the UE being authorized by the authentication server to connect to the WLAN access network, a set of tunnel attributes associated with the UE and provide, to the WLAN AN, the set of tunnel attributes and an indication to establish a tunnel to a particular data network and relay.

### FIELD

The subject matter disclosed herein relates generally to wireless communications and more particularly relates to establishing a compulsory tunnel at a Wireless Local Area Network (“WLAN”) for routing traffic during Non-Seamless WLAN Offloading (“NSWO”).

### BACKGROUND

In certain wireless communication networks, multiple services may be used in a wireless system. In such networks, a network device may not know which user devices are authorized for such services.

### BRIEF SUMMARY

Disclosed are procedures for establishing a compulsory tunnel for NSWO. Said procedures may be implemented by apparatus, systems, methods, or computer program products.

One method of a NSWO function includes receiving a first message indicating that a remote unit requests to connect to the WLAN access network (“WLAN AN”) using credentials associated with the mobile communication network and determining that an authentication server authorizes the remote unit to connect to the WLAN AN. The method includes retrieving an allowed service identity for the remote unit, in response to determining that the authentication server authorizes the remote unit to connect to the WLAN AN, where the allowed service identity identifies a first set of services reachable via the WLAN AN. The method includes determining a set of tunnel attributes associated with the allowed service identity and providing, to the WLAN AN, the set of tunnel attributes and an indication to establish a compulsory tunnel to a first data network and relay all traffic of the remote unit via the compulsory tunnel, where the first data network supports access to the first set of services.

One method of a WLAN AN includes initiating a NSWO authentication procedure with a remote unit and receiving a Network Access Identifier (“NAI”) from the remote unit during the NSWO authentication procedure. Here, the NAI includes a Subscriber Concealed Identity (“SUCI”) of the remote unit and an indication of a first set of requested services to be reachable via the WLAN AN. The method includes sending, to an authentication proxy in a mobile communication network, a first message indicating that the remote unit requests to connect to the WLAN AN using credentials associated with the mobile communication network, where the first message includes the SUCI and the indication of the first set of requested services. The method includes receiving, from the authentication proxy, a set of tunnel attributes and establishing a compulsory tunnel using the set of tunnel attributes. The method includes relaying all traffic of the remote unit via the compulsory tunnel.

One method of a User Data Management server includes receiving, from an authentication server in a mobile communication network, an authentication request including a NSWO indicator and an identity of a remote unit. Here, the authentication request indicates that the remote unit attempts to connect to a WLAN AN using credentials associated with the mobile communication network. The method includes sending, to the authentication server, an authentication vector for the remote unit. The method includes receiving, from a NSWO function and in response to successful authentication of the remote unit, a subscription data request. The method includes sending, to the NSWO function, a subscription data response containing an allowed service identity for the remote unit, where the allowed service identity identifies a first set of services reachable by the remote unit via the WLAN AN.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a block diagram illustrating one embodiment of a wireless communication system for establishing a compulsory tunnel for NSWO;

FIG. 2A is a call-flow diagram illustrating one embodiment of a procedure for NSWO authentication procedure for data network connectivity;

FIG. 2B is a continuation of the call-flow diagram of FIG. 2A;

FIG. 2C is a continuation of the call-flow diagram of FIGS. 2A and 2B;

FIG. 3 is a block diagram illustrating one embodiment of a user equipment apparatus that may be used for establishing a compulsory tunnel for NSWO;

FIG. 4 is a block diagram illustrating one embodiment of a network apparatus that may be used for establishing a compulsory tunnel for NSWO; and

FIG. 5 is a flowchart diagram illustrating one embodiment of a first method for establishing a compulsory tunnel for NSWO;

FIG. 6 is a flowchart diagram illustrating one embodiment of a second method for establishing a compulsory tunnel for NSWO; and

FIG. 7 is a flowchart diagram illustrating one embodiment of a third method for establishing a compulsory tunnel for NSWO.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for establishing a compulsory tunnel for NSWO. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

A user device, e.g., a User Equipment (“UE”), may connect to a WLAN AN for NSWO using credentials of a mobile core network, e.g., a Fifth Generation Core network (“5GC network”). The IP traffic of the UE is directly offloaded to the WLAN AN and does not traverse the mobile core network. However, currently there is no way for the mobile core network-which authenticates the user device-to define services and/or networks available to the user device via the WLAN AN.

Disclosed herein are enhancements to the NSWO authentication procedure which enable a 5GC network to specify the services that should be reachable by the UE after the NSWO authentication procedure and provide tunnelling information to the AN for creating a compulsory tunnel to a data network that offers these services. These enhancements may further enable a UE to provide “hints” to the 5GC network indicating the services that the UE desires to access after the NSWO authentication. By using the novel enhancements of the present disclosure, the 5GC network, not only can authenticate the UE and authorize its connection to a WLAN AN, but it can also configure the WLAN AN to tunnel the UE traffic to a data network that offers the services that should be accessible by the UE via the WLAN AN.

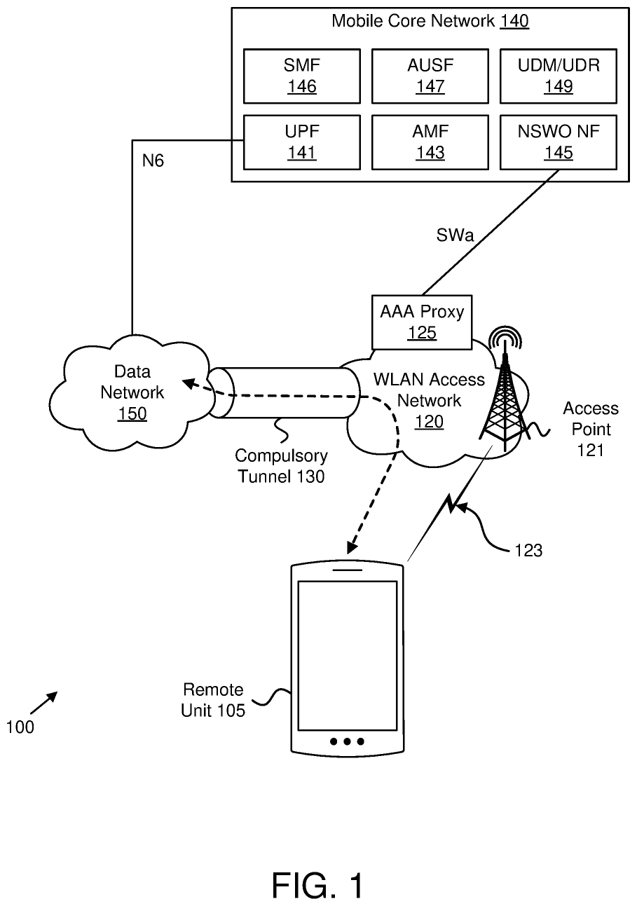

FIG. 1 depicts a wireless communication system 100 for establishing a compulsory tunnel for NSWO, according to embodiments of the disclosure. In one embodiment, the wireless communication system 100 includes at least one remote unit 105, an WLAN access network 120 containing at least one access point 121, and a mobile core network 140. The WLAN access network 120 and the mobile core network 140 may form a mobile communication network. In some embodiments, the mobile communication network may further comprise a Third Generation Partnership Project (“3GPP”) access network (not depicted) containing at least one cellular base unit. The remote unit communicates with the WLAN access network 120 using wireless communication links 123.

Even though a specific number of remote units 105, WLAN access networks 120, access points 121, wireless communication links 123, and mobile core networks 140 are depicted in FIG. 1, one of skill in the art will recognize that any number of remote units 105, WLAN access networks 120, access points 121, wireless communication links 123, and mobile core networks 140 may be included in the wireless communication system 100.

In one implementation, the WLAN access network 120 is compliant with the Wi-Fi® or Institute of Electrical and Electronics Engineers (“IEEE”) 802.11-family of standards. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like.

Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the access points 121 in the WLAN access network 120 via uplink (“UL”) and downlink (“DL”) communication signals. The UL and DL communication signals may be carried over the wireless communication links 123. Furthermore, the UL communication signals may comprise one or more uplink channels, such as the Physical Uplink Control Channel (“PUCCH”) and/or Physical Uplink Shared Channel (“PUSCH”), while the DL communication signals may comprise one or more downlink channels, such as the Physical Downlink Control Channel (“PDCCH”) and/or Physical Downlink Shared Channel (“PDSCH”). Here, the WLAN access network 120 is an intermediate network that provides the remote units 105 with access to a data network 150, e.g., via Non-Seamless WLAN Offloading. In other embodiments, the WLAN access network 120 may provide the remote units 105 with access to the mobile core network 140.

In some embodiments, the remote units 105 communicate with a host (e.g., an application server) in the data network 150 by direct offloading to the WLAN access network 120 without registering to the mobile core network 140 and without establishing a network connection with the mobile core network 140. In various embodiments, the WLAN access network 120 establishes a compulsory tunnel 130 to an endpoint in the data network 150 in order to provide the remote unit 105 an allowed set of services, as described in greater detail below.

However, in other embodiments, the remote units 105 may communicate with the host in the data network 150 via a network connection with the mobile core network 140. For example, an application (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via an access network in the WLAN access network 120. The mobile core network 140 then relays traffic between the remote unit 105 and the remote host, e.g., using the PDU session. The PDU session represents a logical connection between the remote unit 105 and the User Plane Function (“UPF”) 141.

The access points 121 may be distributed over a geographic region. In certain embodiments, an access point 121 may also be referred to as an access terminal, a base unit, a base station, a relay node, a Radio Access Network (“RAN”) node, or by any other terminology used in the art. The access points 121 are generally part of a RAN, such as the WLAN access network 120, that may include one or more controllers communicably coupled to one or more corresponding access points 121. These and other elements of radio access network are not illustrated but are well known generally by those having ordinary skill in the art. The access points 121 connect to the mobile core network 140 via the WLAN access network 120.

The access points 121 may serve a number of remote units 105 within a serving area via a wireless communication link 123. The access points 121 may communicate directly with one or more of the remote units 105 via communication signals. Generally, the access points 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the access points 121.

As depicted, the WLAN access network 120 may include an authentication, authorization, and accounting (“AAA”) proxy 125 used to establish a SWa connection with a NSWO Network Function (“NSWO NF”) 145 in the mobile core network 140. The SWa interface (described in 3GPP Technical Specification (“TS”) 29.273) is used for 3GPP-based access authentication and authorization with an untrusted non-3GPP IP access. Accordingly, a remote unit 105 may use credentials corresponding to the mobile core network 140 (e.g., 5G credentials) to authenticate itself with the WLAN access network 120.

In some embodiments, a WLAN access network 120 may connect to the mobile core network 140 via an interworking function (not depicted) that provides interworking between the remote unit 105 and the mobile core network 140. For example, the interworking function may support connectivity to the mobile core network 140 via the “N2” and “N3” interfaces, and it may relay “N1” signaling between the remote unit 105 and a serving Access and Mobility Management Function (“AMF”) 143. The interworking function also communicates with the UPF 141 using a “N3” interface. Examples of such an interworking function include a Non-3GPP Interworking Function (“N3IWF”) and/or a Trusted Non-3GPP Gateway Function (“TNGF”), as defined in 3GPP.

In one embodiment, the mobile core network 140 is a 5G Core network (“5GC”) or an Evolved Packet Core (“EPC”), which may be coupled to a data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an AMF 143, a Session Management Function (“SMF”) 146, an Authentication Server Function (“AUSF”) 147, a Unified Data Management function (“UDM”) and a User Data Repository (“UDR”). In some embodiments, the UDM is co-located with the UDR, depicted as combined entity “UDM/UDR” 149. Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting a Packet Data Network (“PDN”), in the Fifth Generation (“5G”) architecture. The AMF 143 is responsible for termination of Non-Access Spectrum (“NAS”) signaling, NAS ciphering and integrity protection, registration management, connection management, mobility management, access authentication and authorization, security context management. The SMF 146 is responsible for session management (i.e., session establishment, modification, release), remote unit (i.e., UE) Internet Protocol (“IP”) address allocation and management, DL data notification, and traffic steering configuration of the UPF 141 for proper traffic routing.

The NSWO NF 145, also referred to as a NSWO Function (“NSWOF”), is a new functional element in the 5G network architecture, which interfaces with the WLAN access network 120 (via the SWa interface) and operates as a AAA proxy that interacts with an AUSF 147 in the mobile core network 140. The NSWO NF 145 provides interworking functionality that enables the communication between the WLAN access network 120 and the AUSF 147.

The AUSF 147 acts as an authentication server and/or authentication proxy, thereby allowing a remote unit 105 to be authenticated via the AMF 143 or the WLAN access network 120. The UDM is responsible for generation of Authentication and Key Agreement (“AKA”) credentials (such as Extensible Authentication Protocol Method for 3rd Generation Authentication and Key Agreement (EAP-AKA) credentials or Improved Extensible Authentication Protocol Method for 3rd Generation Authentication and Key Agreement (EAP-AKA′) credentials), user identification handling, access authorization, subscription management. The UDR is a repository of subscriber information and may be used to service a number of network functions. For example, the UDR may store subscription data, policy-related data, subscriber-related data that is permitted to be exposed to third party applications, and the like.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), a Policy Control Function (“PCF”) (which is responsible for unified policy framework, providing policy rules to CP functions, access subscription information for policy decisions in UDR), or other NFs defined for the 5GC. In certain embodiments, the mobile core network 140 may include an AAA server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 146 and UPF 141. In some embodiments, the different network slices may share some common network functions, such as the AMF 143. The different network slices are not shown in FIG. 1 for ease of illustration, but their support is assumed.

While FIG. 1 depicts components of a WLAN access network (“WLAN AN”) and a 5G core (“5GC”) network, the described embodiments for establishing a compulsory tunnel for NSWO apply to other types of communication networks and RATs, including 3GPP New Radio (“NR”), 3GPP Long-Term Evolution (“LTE”), Global System for Mobile Communications (“GSM”, i.e., a 2G digital cellular network), General Packet Radio Service (“GPRS”), Universal Mobile Telecommunications System (“UMTS”), LTE variants, CDMA2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PDN Gateway (“PGW”), a Home Subscriber Server (“HSS”), and the like. For example, the AMF 143 may be mapped to an MME, the SMF 146 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “AP” may be used for the access point, but it is replaceable by any other radio access node, e.g., RAN node, Base Station (“BS”), Transmission and Reception Point (“TRP”), etc. Additionally, the term “UE” is used for the mobile station/remote unit, but it is replaceable by any other remote device, e.g., remote unit, MS, ME, etc. Further, the operations are described mainly in the context of the 5GC network. However, the below described solutions/methods are also equally applicable to other mobile communication systems for establishing a compulsory tunnel for NSWO.

The 3GPP Rel-17 specifications were recently enhanced to support WLAN connection using 5G credentials without 5G system (“5GS”) registration. Essentially, a new procedure was specified that enables a UE to connect to a WLAN AN using its 5G credentials without the UE registering with a 5GC network. This procedure is called Non-Seamless WLAN Offload (“NSWO”) authentication procedure.

After the NSWO authentication procedure is successfully completed, the UE is connected to the WLAN AN and can use this WLAN AN for initiating IP communication. The IP traffic of the UE is directly offloaded to the WLAN AN and does not traverse the 5GC network. The 5GC network is only used for authenticating the UE and authorizing its connection to the WLAN AN.

However, in many scenarios, the 5GC network does not only want to authenticate the UE and authorize its connection to the WLAN AN. It wants also to define which data network the UE should be able to reach after the successful NSWO authentication procedure. The data network that is reachable by the UE determines the services that are available to the UE after being connected to the WLAN AN.

For example, the 5GC network may want the UE to access IP Multimedia System (“IMS”) services after being connected to the WLAN AN, which are offered via a first data network. Or the 5GC network may want the UE to access edge computing services after being connected to the WLAN AN, which are offered via a second data network. Or the 5GC network may want the UE to access some IoT services after being connected to the WLAN AN, which are offered via a third data network.

This requirement, i.e., for the 5GC network to be able to specify which data network the UE should be able to reach after the successful NSWO authentication, is not currently supported. However, by using the novel enhancements of the present disclosure, the 5GC network, not only can authenticate the UE and authorize its connection to a WLAN AN, but it can also configure the WLAN AN to tunnel the UE traffic to a data network that offers the services that should be accessible by the UE via the WLAN AN.

Disclosed herein are procedures and example implementations of establishing a compulsory tunnel between the WLAN access network 120 and the Data Network 150 for relaying all data traffic between a UE (e.g., the remote unit 105) to the Data Network 150. The compulsory tunnel is selected by the mobile core network 140, thereby enabling the UE to reach all services accessible via the Data Network 150.

The UE selects and connects to a WLAN AN (e.g., the WLAN access network 120) using 5G credentials held in the UE (e.g., in a Universal Subscriber Identity Module (“USIM”) module) and in the mobile core network 140. The UE is authorized to connect to the WLAN access network 120 after successfully conducting a NSWO authentication procedure, wherein the UE and the AUSF 147 in the mobile core network 140 are mutually authenticated.

Note that the WLAN access network 120 must support an SWa interface with the mobile core network 140, which is used during the NSWO authentication procedure. In a typical scenario, before the UE attempts to connect to the WLAN access network 120 using its 5G credentials, the UE discovers that the WLAN access network 120 supports AAA interworking with the mobile core network 140, meaning that it supports a SWa interface with the mobile core network 140.

After the UE connects to the WLAN access network 120 using its 5G credentials, a compulsory tunnel is created between the WLAN access network 120 and a Data Network 150, which is selected by the mobile core network 140. This tunnel is used for relaying all data traffic between the UE to the Data Network 150 and, therefore, enables the UE to reach all services accessible via the Data Network 150.

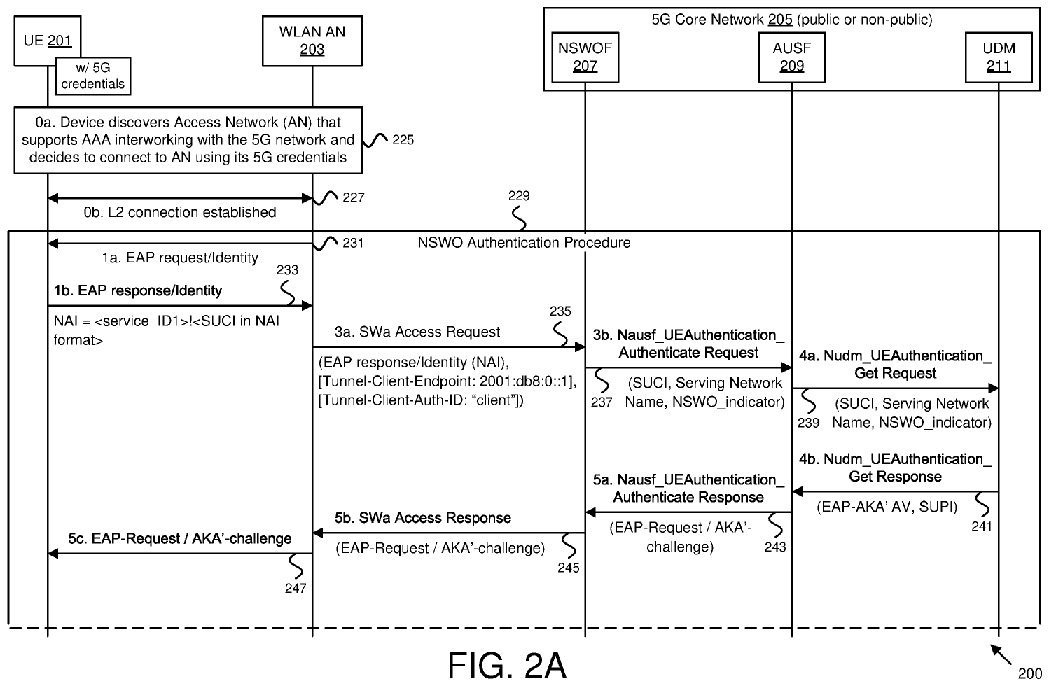

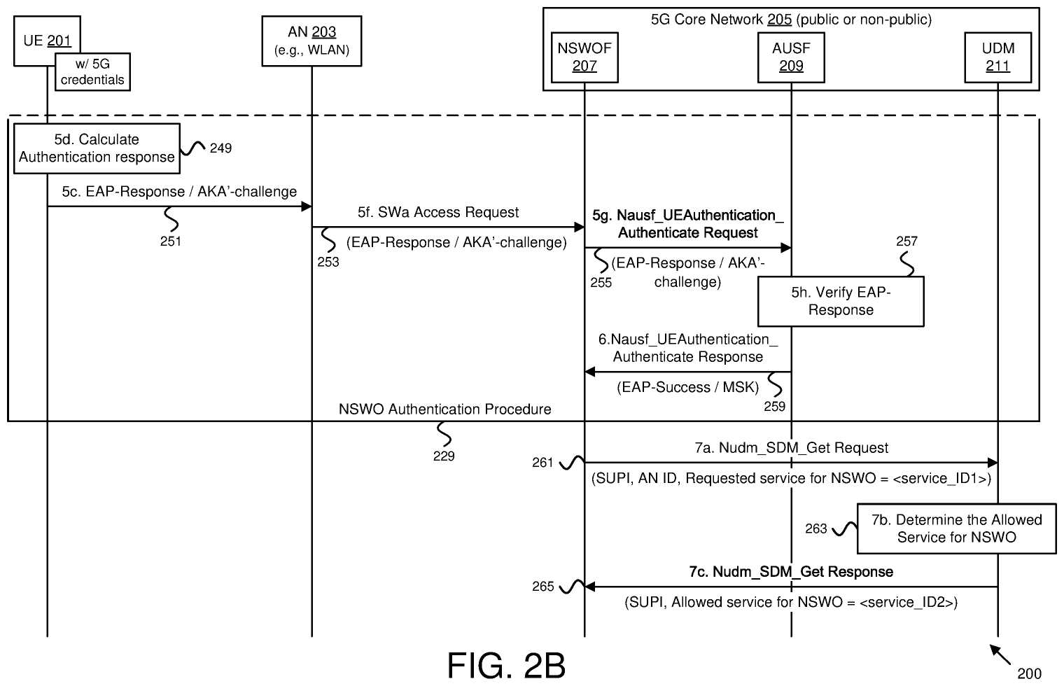

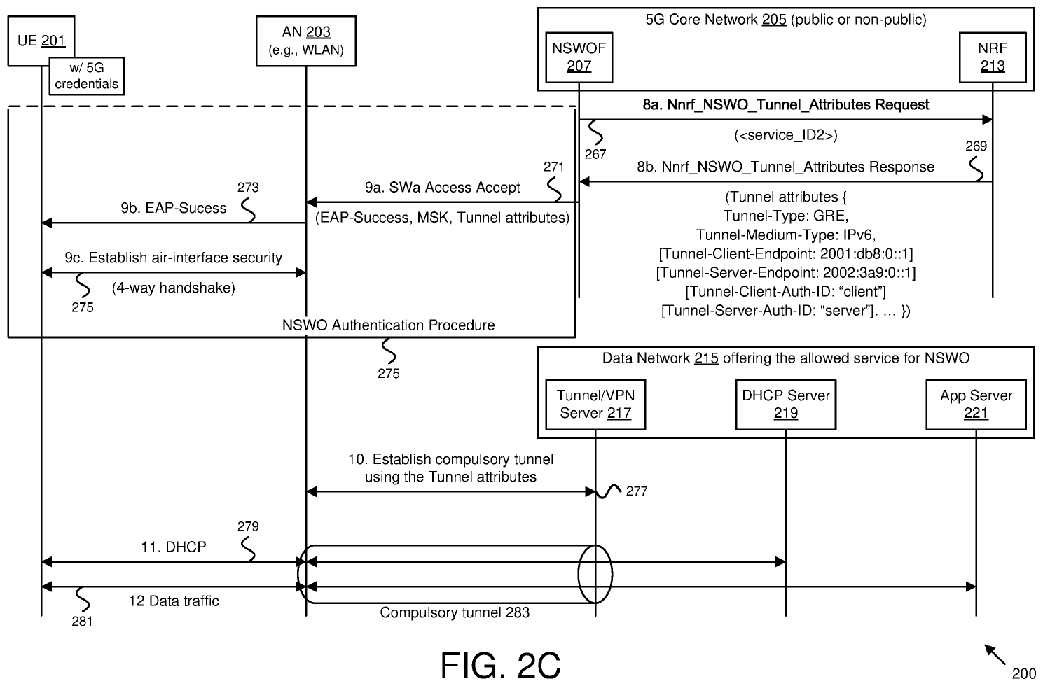

FIGS. 2A-2C depict a procedure 200 for enable a 5GC network to specify the data network which should be reachable by the UE after being successfully authenticated to the WLAN AN during a NSWO authentication procedure, according to embodiments of the disclosure. The procedure 200 involves the UE 201 (e.g., an embodiment of the remote unit 105) having a set of 5G credentials, the WLAN AN 203 (e.g., an embodiment of the WLAN access network 120), and a 5G core network 205 (e.g., public or non-public network) containing a NSWOF 207 (e.g., an embodiment of the NSWO NF 145), an AUSF 209 (e.g., an embodiment of the AUSF 147), a UDM 211 (e.g., an embodiment of the UDM/UDR 149), a N3IWF 209 (e.g., one embodiment of the interworking function 137), and a NRF 213. After successful NSWO authentication of the UE 201, the WLAN AN 203 establishes a compulsory tunnel with the data network 215 offering an allowed service for NSWO, as described in greater detail below. The data network 215 contains at least a Tunnel Server or Virtual Private Network (“VPN”) server (depicted as “Tunnel/VPN server” 217, a Dynamic Host Configuration Procedure (“DHCP”) server 219, and an application server (depicts as “App Server 221”).

Starting on FIG. 2A, the procedure 200 begins at Step 0a when the UE 201 discovers an Access Network (“AN”) and determines, using known procedures, that it supports AAA interworking with the 5G core network that holds credentials for authenticating the UE (aka the “home” network) (see block 225). This 5G core network could be either a public network (e.g., PLMN) or a non-public network, such as a standalone non-public network (“SNPN”). As an example, the AN may advertise that is supports AAA interworking with one or more networks using the Access Network Query Protocol (“ANQP”). ANQP is a query and response protocol which may be used to define services offered by an access point (“AP”) in the WLAN AN.

At Step 0b, having decided to connect to this access network using its 5G credentials, the UE 201 proceeds to establish a Layer-2 connection with the WLAN AN 203 (see signaling 227). In the case where the access network is a WLAN AN, the Layer-2 connection is an IEEE 802.11 association.

At Step 1a, the WLAN AN 203 initiates a Non-Seamless WLAN Offload authentication procedure 229 and requests the identity of the UE 201 (see signaling 231). This NSWO authentication procedure 229 applies the Extensible Authentication Protocol (“EAP”) for mutually authenticating the UE 201 and the 5G core network 205.

At Step 1b, the UE provides its Network Access Identifier (“NAI”), which contains a Subscriber Concealed Identity (“SUCI”) formatted as a network specific identifier (see signaling 233). In certain embodiments, the UE 201 may “decorate” the NAI by including a service identity parameter (depicted in FIG. 2A as “service_ID1”) that specifies a set of services requested by the UE 201 to be reachable via the AN.

As an example, the parameter service_ID1 could take the value “ims” or “internet” to indicate that the UE 201 requests to access IMS services or the Internet, respectively, after connecting to the WLAN AN 203. Note that the service_ID1 is an optional element and provides a suggestion to the network for determining the services that should be reachable by the UE 201 via the WLAN AN 203. Although FIGS. 2A-2C use the term “service identity”, alternatively, the hint/suggestion provided by the UE 201 may be referred to as a “connection capability”.

An example of a decorated NAI is the following: “ims!type1.rid678.schid1.hnkey27.ecckey<ECC (elliptic curve cryptography) ephemeral public key>.cip<encryption of user17>.mac<MAC tag value>@example.com”. Note that the SUCI element of NAI comprises a concealed username (i.e., “type1.rid678.schid1.hnkey27.ecckey.cip.mac”) and a realm (i.e., “example.com”) which identifies the network that should be involved in the NSWO authentication procedure (in this case, the illustrated 5G core network 205).

At Step 3a, the WLAN AN 203 resolves the realm into an IP address (e.g., using Domain Name System (“DNS”) procedures) of and sends an SWa Access Request message to this IP address, which belongs to the NSWOF 207 in the 5G core network 205 (see signaling 235). Here, the NSWOF 207 may act as a Service-Based Interface (“SBI”) AAA proxy between the AUSF 209 and the WLAN AN 203.

At Step 3b, the NSWOF 207 sends a first authentication request message (e.g., a Nausf_UEAuthentication_Authenticate or Nausf_UEAuthentication_NSWOAuthenticate Request message) to the AUSF 209, which message contains the SUCI, a Serving Network name and an NSWO indicator (see signaling 237). The NSWO_indicator is used to indicate to the AUSF 209 that the authentication request is for NSWO purposes. In certain embodiments, the NSWOF 207 may set the Serving Network name to “5G:NSWO”.

At Step 4a, the AUSF 209 (acting as the EAP authentication server) sends a second authentication request message (e.g., a Nudm_UEAuthentication_Get or Nudm_UEAuthentication_GetNSWO Request message) to the UDM 211, which message also contains the SUCI and the NSWO indicator (see signaling 239).

At Step 4b, upon reception of the Nudm_UEAuthentication_Get Request (alternatively, the Nudm_UEAuthentication_GetNSWO Request), the UDM 211 selects the EAP-AKA′ authentication method based on the NSWO indicator. In certain embodiments, the UDM 211 invokes an Authentication Credential Repository Processing Function (“ARPF”) to select the authentication method. In certain embodiments, the UDM 211 may invoke a Subscriber Identity De-concealing Function (“SIDF”) to de-conceal the SUCI to gain a corresponding subscriber permanent identity (“SUPI”) before UDM can process the request.

Additionally, the UDM 211 generates the EAP-AKA′ authentication vector (“AV”) and may include SUPI to AUSF in a Nudm_UEAuthentication_Get Response message. Note that UDM 211 may invoke the ARPF to generate the EAP-AKA′ AV. In various embodiments, the EAP-AKA′ AV contains the following parameters: RAND (a nonce/random number), AUTN (an authentication token), XRES (the expected/correct result), CK′ (a cipher key), and IK′ (an integrity key). The UDM 211 transmits a first authentication response message (e.g., a Nudm_UEAuthentication_Get or Nudm_UEAuthentication_GetNSWO Response message) to the AUSF 209, which message contains the EAP-AKA′ AV and the SUPI (see signaling 241). The AUSF 209 stores the XRES for future verification.

At Step 5a, the AUSF 209 sends an EAP-Request/AKA′-Challenge message to the NSWOF 207 in a Nausf_UEAuthentication_Authenticate Response message (alternatively, a Nausf_UEAuthentication_NSWOAuthenticate Response message) (see signaling 243). Here, the RAND and AUTN are delivered in the EAP-Request/AKA′-Challenge message.

At Step 5b, the NSWOF 207 sends the EAP-Request/AKA′-Challenge message to the WLAN AN 203 over the SWa interface (see signaling 245).

At Step 5c, the WLAN AN 207 forwards the EAP-Request/AKA′-Challenge message to the UE 201 (see signaling 247).

Continuing on FIG. 2B, at Step 5d, the UE 201 calculates an authentication response (see block 249). For example, upon receipt of the RAND and AUTN in the EAP-Request/AKA′-Challenge message, the ME of the UE 201 constructs the Serving Network name by setting it to “5G:NSWO”, and the USIM in the UE 201 verifies the freshness of the AV′, e.g., by checking whether AUTN can be accepted as described in TS 33.102. If so, the USIM computes RES (a response). The USIM returns RES, CK, IK to the ME, and the ME derives CK′ and IK′. The UE 201 may derive a Master Session Key (“MSK”) from CK′ and IK′ as described in Internet Engineering Task Force (“IETF”) Request-For-Comment (“RFC”) 5448. Note that, when the UE 201 is performing NSWO authentication, the key KAUSF is not generated by the UE 201.

At Step 5e, the UE 201 sends an EAP-Response/AKA′-Challenge message to the WLAN AN 203 (see signaling 251). Note that the EAP-Response/AKA′-Challenge message contains the RES generated by the UE 201.

At Step 5f, the WLAN AN 203 forwards the EAP-Response/AKA′-Challenge message over the SWa interface to the NSWOF 207 (see signaling 253).

At Step 5g, the NSWOF 207 sends a Nausf_UEAuthentication_Authenticate Request with the EAP-Response/AKA′-Challenge message to the AUSF 209 (see signaling 255).

At Step 5h, the AUSF 209 verifies whether the received response RES matches the stored and expected response XRES (see block 255). If so, then the AUSF 209 has successfully verified the UE 201, and it continues as follows to step 6; otherwise, the AUSF 209 returns an error to the NSWOF 207. The AUSF 209 derives the required MSK key from CK′ and IK′ (e.g., as described in IETF RFC 5448), based on the NSWO indicator received in step 5. Note that, when the UE 201 is performing NSWO authentication, the AUSF 209 does not generate the key KAUSF.

At Step 6, the AUSF 209 sends a Nausf_UEAuthentication_Authenticate Response message with EAP-Success packet and the MSK key to the NSWOF 207 (see signaling 257). The AUSF 209 may optionally provide the SUPI to the NSWOF 207. The message in step 6 indicates that the AUSF has successfully authenticated the UE 201.

The NSWOF 207 does not send immediately the SWa Access Accept message, as defined in the 3GPP TS 33.501, Annex S. Rather, the NSWOF 207 sends this message later (in step 9a), after receiving a set of tunnel attributes, which specify how the WLAN AN 203 can establish a compulsory tunnel to the data network that offers the services (e.g., “ims”) to be used by the UE 201 via the WLAN AN 203.

At Step 7a, the NSWOF 207 sends a request message to the UDM 211 requesting the “Allowed service for NSWO” for the UE 201 (see signaling 261). This message comprises the UE 201′s identity (e.g., SUPI) and, optionally, the identity of the WLAN AN 203 (e.g., AN ID) and the service identity requested by the UE 201 (service_ID1), if this was provided in step 1b.

In step 7b, the UDM 211 determines the “Allowed service for NSWO” for the UE 201 by using one or more of: configuration information, UE subscription data, the AN ID, and the service identity (i.e., service_ID1) requested by the UE 201 (see block 263). The provision of the AN ID makes it possible for the UDM 211 to select a different “Allowed service for NSWO” for different ANs.

In step 7c, the NSWOF 207 receives a response message from the UDM 211 including the parameter “Allowed service for NSWO” (depicted in FIG. 2B as “service_ID2”) that specifies a set of services allowed for the UE 201 (see signaling 265). Note that, in several situations, the service_ID2 would be the same as the service_ID1, i.e., the “Allowed service for NSWO” would be the same as the “Requested service for NSWO”.

Continuing on FIG. 2C, at Step 8, the NSWOF 207 determines a set of tunnel attributes corresponding to the received “Allowed service for NSWO” (service_ID2). This determination can be done either by using configuration information in the NSWOF 207, or by interrogating the Network Repository Function (“NRF”) 213 in the 5G core network 205, as shown in FIG. 2C.

At Step 8a, in the latter case, the NSWOF 207 sends a request message to the NRF 213 containing the “Allowed service for NSWO” parameter (i.e., service_ID2) (see signaling 267). At Step 8b, the NSWOF 207 receives a response message from the NRF 213 with the set of tunnel attributes corresponding to the “Allowed service for NSWO” (see signaling 269).

The set of tunnel attributes contains parameters that can be used by the AN to establish a compulsory tunnel to a data network and then relay all UE traffic via this compulsory tunnel. FIG. 2C, illustrates several such parameters, such as, the Tunnel-Type, the Tunnel-Medium-Type, the Tunnel-Client-Endpoint, etc. In certain embodiments, the kinds and values of the tunnel attributes may include those defined in IETF RFC 2868 for the RADIUS protocol.

At Step 9a, the NSWOF 207 continues the NSWO authentication procedure and sends an SWa Access Accept message to the WLAN AN 203 (see signaling 271) the SWa interface. Here, the Access Accept message comprises the EAP-success packet and the MSK (received in Step 6) and also comprises the received tunnel attributes. Note that the existing NSWO authentication procedure specified in 3GPP TS 33.501 does not include such tunnel attributes in the SWa Access Accept message.

At Step 9b, the WLAN AN 203 sends the EAP-Success message to the UE 201, which successfully completes the NSWO authentication procedure 229 (see signaling 273).

At Step 9c, the UE 201 and the WLAN AN 203 apply the common MSK to derive keys for securing the unicast and broadcast traffic over the air-interface (if not derived earlier) and establish the air-interface security for NSWO, e.g., by using the 4-way handshake specified in IEEE 802.11X to establish a secure connection (see signaling 275).

At Step 10, the WLAN AN 203 applies the received tunnel attributes to establish a compulsory tunnel 283 (see signaling 277) and then relays all traffic of the UE 201 via this compulsory tunnel. The endpoint of this compulsory tunnel 283 is typically at a tunnel/VPN server 217 in the data network 215 which offers the allowed services for the UE 201.

At Step 11, the UE 201 receives IP configuration data from a DHCP server 219 in the data network 215, e.g., by using the DHCP protocol (see signaling 279).

At Step 12, all data traffic of the UE 201 is relayed to the data network 215 via the compulsory tunnel 283, thereby enabling the UE 201 to reach all services accessible via this data network 215, e.g., a first service provided by the App Server 221 (see signaling 281). The procedure 200 ends.

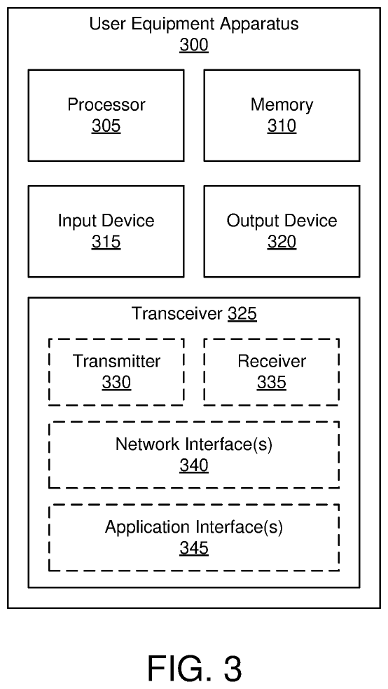

FIG. 3 depicts one embodiment of a user equipment apparatus 300 that may be used for establishing a compulsory tunnel for NSWO, according to embodiments of the disclosure. The user equipment apparatus 300 may be one embodiment of the remote unit 105 and/or the UE 201. Furthermore, the user equipment apparatus 300 may include a processor 305, a memory 310, an input device 315, an output device 320, a transceiver 325.

In some embodiments, the input device 315 and the output device 320 are combined into a single device, such as a touchscreen. In certain embodiments, the user equipment apparatus 300 may not include any input device 315 and/or output device 320. In various embodiments, the user equipment apparatus 300 may include one or more of: the processor 305, the memory 310, and the transceiver 325, and may not include the input device 315 and/or the output device 320.

As depicted, the transceiver 325 includes at least one transmitter 330 and at least one receiver 335. In some embodiments, the transceiver 325 communicates with one or more cells (or wireless coverage areas) supported by one or more satellites, cellular base units, and/or access points 121. In various embodiments, the transceiver 325 is operable on unlicensed spectrum. Moreover, the transceiver 325 may include multiple UE panels supporting one or more beams. Additionally, the transceiver 325 may support at least one network interface 340 and/or application interface 345. The application interface(s) 345 may support one or more APIs. The network interface(s) 340 may support 3GPP reference points, such as Uu, N1, PC5, etc. Other network interfaces 340 may be supported, as understood by one of ordinary skill in the art.

The processor 305, in one embodiment, may include any known controller capable of executing computer-readable instructions and/or capable of performing logical operations. For example, the processor 305 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 305 executes instructions stored in the memory 310 to perform the methods and routines described herein. The processor 305 is communicatively coupled to the memory 310, the input device 315, the output device 320, and the transceiver 325.

In various embodiments, the transceiver 325 is configured to communicate with an authentication proxy in a mobile communication network via a WLAN AN. Via the transceiver 325, the processor 305 discovers the WLAN AN that supports AAA interworking with the mobile communication network (e.g., a 5GC network) and connects to the WLAN AN. In response to an identity request, the processor 305 generates a NAI that comprises a service identity, a concealed username, and a realm. In some embodiments, the service identity specifies a set of services requested by the apparatus 300.

The memory 310, in one embodiment, is a computer readable storage medium. In some embodiments, the memory 310 includes volatile computer storage media. For example, the memory 310 may include a RAM, including dynamic RAM (“DRAM”), synchronous dynamic RAM (“SDRAM”), and/or static RAM (“SRAM”). In some embodiments, the memory 310 includes non-volatile computer storage media. For example, the memory 310 may include a hard disk drive, a flash memory, or any other suitable non-volatile computer storage device. In some embodiments, the memory 310 includes both volatile and non-volatile computer storage media.

In some embodiments, the memory 310 stores data related to establishing a compulsory tunnel for NSWO. For example, the memory 310 may store various parameters, panel/beam configurations, resource assignments, policies, and the like as described above. In certain embodiments, the memory 310 also stores program code and related data, such as an operating system or other controller algorithms operating on the user equipment apparatus 300.

The input device 315, in one embodiment, may include any known computer input device including a touch panel, a button, a keyboard, a stylus, a microphone, or the like. In some embodiments, the input device 315 may be integrated with the output device 320, for example, as a touchscreen or similar touch-sensitive display. In some embodiments, the input device 315 includes a touchscreen such that text may be input using a virtual keyboard displayed on the touchscreen and/or by handwriting on the touchscreen. In some embodiments, the input device 315 includes two or more different devices, such as a keyboard and a touch panel.

The output device 320, in one embodiment, is designed to output visual, audible, and/or haptic signals. In some embodiments, the output device 320 includes an electronically controllable display or display device capable of outputting visual data to a user. For example, the output device 320 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 320 may include a wearable display separate from, but communicatively coupled to, the rest of the user equipment apparatus 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

In certain embodiments, the output device 320 includes one or more speakers for producing sound. For example, the output device 320 may produce an audible alert or notification (e.g., a beep or chime). In some embodiments, the output device 320 includes one or more haptic devices for producing vibrations, motion, or other haptic feedback. In some embodiments, all or portions of the output device 320 may be integrated with the input device 315. For example, the input device 315 and output device 320 may form a touchscreen or similar touch-sensitive display. In other embodiments, the output device 320 may be located near the input device 315.

The transceiver 325 communicates with one or more network functions of a mobile communication network via one or more access networks. The transceiver 325 operates under the control of the processor 305 to transmit messages, data, and other signals and also to receive messages, data, and other signals. For example, the processor 305 may selectively activate the transceiver 325 (or portions thereof) at particular times in order to send and receive messages.

The transceiver 325 includes at least transmitter 330 and at least one receiver 335. One or more transmitters 330 may be used to provide UL communication signals to an access point 121, such as the UL transmissions described herein. Similarly, one or more receivers 335 may be used to receive DL communication signals from the access point 121, as described herein. Although only one transmitter 330 and one receiver 335 are illustrated, the user equipment apparatus 300 may have any suitable number of transmitters 330 and receivers 335. Further, the transmitter(s) 330 and the receiver(s) 335 may be any suitable type of transmitters and receivers. In one embodiment, the transceiver 325 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 325, transmitters 330, and receivers 335 may be implemented as physically separate components that access a shared hardware resource and/or software resource, such as for example, the network interface 340.

In various embodiments, one or more transmitters 330 and/or one or more receivers 335 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 330 and/or one or more receivers 335 may be implemented and/or integrated into a multi-chip module. In some embodiments, other components such as the network interface 340 or other hardware components/circuits may be integrated with any number of transmitters 330 and/or receivers 335 into a single chip. In such embodiment, the transmitters 330 and receivers 335 may be logically configured as a transceiver 325 that uses one more common control signals or as modular transmitters 330 and receivers 335 implemented in the same hardware chip or in a multi-chip module.

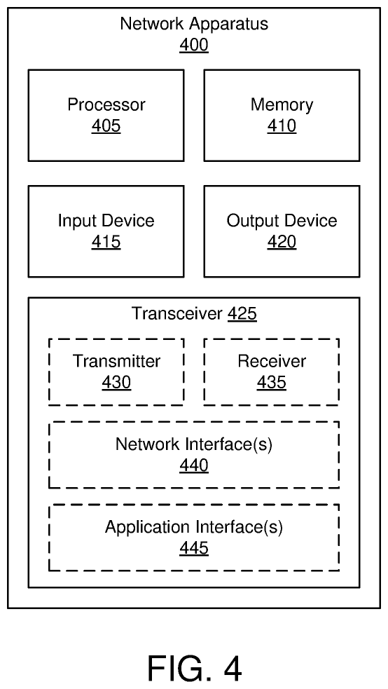

FIG. 4 depicts one embodiment of a network apparatus 400 that may be used for establishing a compulsory tunnel for NSWO, according to embodiments of the disclosure. In some embodiments, the network apparatus 400 may implement an AMF and/or a UPF. In further embodiments, the network apparatus 400 may implement an interworking function, such as the N3IWF and/or TNGF. Furthermore, network apparatus 400 may include a processor 405, a memory 410, an input device 415, an output device 420, a transceiver 425.

In some embodiments, the input device 415 and the output device 420 are combined into a single device, such as a touchscreen. In certain embodiments, the network apparatus 400 may not include any input device 415 and/or output device 420. In various embodiments, the network apparatus 400 may include one or more of: the processor 405, the memory 410, and the transceiver 425, and may not include the input device 415 and/or the output device 420.

As depicted, the transceiver 425 includes at least one transmitter 430 and at least one receiver 435. Here, the transceiver 425 communicates with one or more remote units 105. Additionally, the transceiver 425 may support at least one network interface 440 and/or application interface 445. The application interface(s) 445 may support one or more APIs. The network interface(s) 440 may support 3GPP reference points, such as Uu, N1, N2 and N3. Other network interfaces 440 may be supported, as understood by one of ordinary skill in the art.

The processor 405, in one embodiment, may include any known controller capable of executing computer-readable instructions and/or capable of performing logical operations. For example, the processor 405 may be a microcontroller, a microprocessor, a CPU, a GPU, an auxiliary processing unit, a FPGA, or similar programmable controller. In some embodiments, the processor 405 executes instructions stored in the memory 410 to perform the methods and routines described herein. The processor 405 is communicatively coupled to the memory 410, the input device 415, the output device 420, and the transceiver 425.

In various embodiments, the network apparatus 400 is a RAN node (e.g., gNB) that communicates with one or more UEs, as described herein. In such embodiments, the processor 405 controls the network apparatus 400 to perform the above described RAN behaviors. When operating as a RAN node, the processor 405 may include an application processor (also known as “main processor”) which manages application-domain and operating system (“OS”) functions and a baseband processor (also known as “baseband radio processor”) which manages radio functions.

In various embodiments, the network apparatus 400 acts as an access network entity, such as the access point 121 and/or the WLAN NF 203, described above. In such embodiments, the transceiver 425 may be configured to communicate with a remote unit and one or more network functions in a mobile communication network. Via the transceiver 425, the processor 405 initiates a NSWO authentication procedure with the remote unit and receives a NAI from the remote unit during the NSWO authentication procedure. In some embodiments, the NAI includes a SUCI of the remote unit and an indication of a first set of requested services to be reachable via the access network.

Via the transceiver 425, the processor 405 sends, to an authentication proxy in the mobile communication network (e.g., a NSWOF), a first message indicating that the remote unit requests to use credentials associated with the mobile communication network to connect to the access network, where the first message includes the SUCI and the indication of the first set of requested services. Additionally, the processor 405 receives, from the authentication proxy, a set of tunnel attributes. In some embodiments, to, the processor receives the set of tunnel attributes by receiving an access accept message including the set of tunnel attributes, a success indication, and a session key. In some embodiments, the first message and the access accept message are SWa protocol messages exchanged during the NSWO authentication procedure.

The processor 405 establishes a compulsory tunnel using the set of tunnel attributes; and relays all traffic of the remote unit via the compulsory tunnel. In some embodiments, the processor establishes the compulsory tunnel with a server in a first data network, where the first data network supports access to an allowed set of services. In various embodiments, the set of tunnel attributes includes one or more of: A) a tunnel type, B) a tunnel medium type, C) a tunnel client endpoint, D) a tunnel server endpoint, E) a tunnel client authentication identifier, F) a tunnel server authentication identifier, or G) some combination thereof.

In various embodiments, the network apparatus 400 acts as a NSWOF entity in a mobile communication network, such as the NSWO NF 145 in the mobile core network 140 and/or the NSWOF 207 in the 5GC network 205, described above. In such embodiments, the transceiver 425 may be configured to communicate with a WLAN AN and with one or more network functions in the mobile communication network. Via the transceiver 425, the processor 405 receives a first message indicating that a remote unit requests to use credentials associated with the mobile communication network to connect to the WLAN AN and determines that an authentication server authorizes the remote unit to connect to the WLAN AN. In some embodiments, the first message contains a SUCI of the remote unit and an indication of a second set of services to be reachable via the WLAN AN.

The processor 405 retrieves an allowed service identity for the remote unit, in response to determining that the authentication server authorizes the remote unit to connect to the WLAN AN, where the allowed service identity identifies a first set of services reachable via the WLAN AN. In some embodiments, to retrieve the allowed service identity, the processor sends, to a UDM in the mobile communication network, a request message and B) receive, from the UDM, a response message. In such embodiments, the request message may include an access network identifier and a requested service identity, where the requested service identity identifies a second set of services to be reachable via the WLAN AN, and the response message may include the allowed service identity.

The processor 405 determines a set of tunnel attributes associated with the allowed service identity. In some embodiments, the processor 405 determines the set of tunnel attributes by using configuration information. In other embodiments, the processor 405 determines the set of tunnel attributes by interrogating an NRF in the mobile communication network, e.g., via the transceiver 425. In certain embodiments, the processor sends, to the NRF, a request message contains the allowed service identity and receives, from the NRF, a response message containing the set of tunnel attributes associated with the allowed service identity.

Via the transceiver 425, the processor 405 provides, to the WLAN AN, the set of tunnel attributes and an indication to establish a compulsory tunnel to a first data network and relay all traffic of the remote unit via the compulsory tunnel, where the first data network supports access to the first set of services. In one embodiment, the message containing the set of tunnel attributes may include an explicit indication to establish a compulsory tunnel to a first data network and relay all traffic of the remote unit via the compulsory tunnel. For example, the message may include a flag or field used to explicitly indicate the compulsory tunnel. In another embodiment, the message containing the set of tunnel attributes may include an implicit indication. For example, the indication may be implied by the type of message used to provide the tunnel attributes. As another example, the indication may be implied by the presence of the tunnel attributes parameter, etc.

In some embodiments, to provide the set of tunnel attributes, the processor is configured to send, to the WLAN AN, an access accept message contains the set of tunnel attributes, a success indication, and a session key. In some embodiments, the first message and the access accept message are SWa protocol messages exchanged during a NSWO authentication procedure. In other embodiments, to determine the set of tunnel attributes, the processor is configured to receive configuration information, wherein the set of tunnel attributes is determined from the allowed service identity, using the received configuration information. In various embodiments, the set of tunnel attributes includes one or more of: A) a tunnel type, B) a tunnel medium type, C) a tunnel client endpoint, D) a tunnel server endpoint, E) a tunnel client authentication identifier, F) a tunnel server authentication identifier, or G) some combination thereof.

In various embodiments, the network apparatus 400 acts as a user data management server, such as the UDM/UDR 149 and/or the UDM 211, as described above. In such embodiments, the transceiver 425 may be configured to communicate with an authentication server (e.g., an AUSF) and with an NSWO function in the mobile communication network. Via the transceiver 425, the processor 405 receives, from the authentication server, an authentication request including a NSWO indicator and an identity of a remote unit and sends, to the authentication server, an authentication vector for the remote unit. Here, the authentication request indicates that the remote unit attempts to use credentials associated with the mobile communication network to connect to a WLAN AN.

Via the transceiver 425, the processor 405 receives, from a NSWO function and in response to successful authentication of the remote unit, a subscription data request and sends, to the NSWO function, a subscription data response containing an allowed service identity for the remote unit, where the allowed service identity identifies a first set of services reachable by the remote unit via the WLAN AN.

In some embodiments, the subscription data request message includes a SUPI of the remote unit and a requested service identity identifying a second set of services to be reachable via the WLAN. In some embodiments, the processor 405 determines the allowed service identity using: A) configuration information, B) subscription data corresponding to the remote unit, C) an access network identity of the WLAN AN, D) a requested service identity, or E) some combination thereof.

The memory 410, in one embodiment, is a computer readable storage medium. In some embodiments, the memory 410 includes volatile computer storage media. For example, the memory 410 may include a RAM, including DRAM, SDRAM, and/or SRAM. In some embodiments, the memory 410 includes non-volatile computer storage media. For example, the memory 410 may include a hard disk drive, a flash memory, or any other suitable non-volatile computer storage device. In some embodiments, the memory 410 includes both volatile and non-volatile computer storage media.

In some embodiments, the memory 410 stores data related to establishing a compulsory tunnel for NSWO. For example, the memory 410 may store parameters, configurations, resource assignments, policies, and the like, as described above. In certain embodiments, the memory 410 also stores program code and related data, such as an operating system or other controller algorithms operating on the network apparatus 400.

The input device 415, in one embodiment, may include any known computer input device including a touch panel, a button, a keyboard, a stylus, a microphone, or the like. In some embodiments, the input device 415 may be integrated with the output device 420, for example, as a touchscreen or similar touch-sensitive display. In some embodiments, the input device 415 includes a touchscreen such that text may be input using a virtual keyboard displayed on the touchscreen and/or by handwriting on the touchscreen. In some embodiments, the input device 415 includes two or more different devices, such as a keyboard and a touch panel.

The output device 420, in one embodiment, is designed to output visual, audible, and/or haptic signals. In some embodiments, the output device 420 includes an electronically controllable display or display device capable of outputting visual data to a user. For example, the output device 420 may include, but is not limited to, an LCD display, an LED display, an OLED display, a projector, or similar display device capable of outputting images, text, or the like to a user. As another, non-limiting, example, the output device 420 may include a wearable display separate from, but communicatively coupled to, the rest of the network apparatus 400, such as a smart watch, smart glasses, a heads-up display, or the like. Further, the output device 420 may be a component of a smart phone, a personal digital assistant, a television, a table computer, a notebook (laptop) computer, a personal computer, a vehicle dashboard, or the like.

In certain embodiments, the output device 420 includes one or more speakers for producing sound. For example, the output device 420 may produce an audible alert or notification (e.g., a beep or chime). In some embodiments, the output device 420 includes one or more haptic devices for producing vibrations, motion, or other haptic feedback. In some embodiments, all or portions of the output device 420 may be integrated with the input device 415. For example, the input device 415 and output device 420 may form a touchscreen or similar touch-sensitive display. In other embodiments, the output device 420 may be located near the input device 415.

The transceiver 425 includes at least transmitter 430 and at least one receiver 435. One or more transmitters 430 may be used to communicate with the UE, as described herein. Similarly, one or more receivers 435 may be used to communicate with network functions in the PLMN and/or RAN, as described herein. Although only one transmitter 430 and one receiver 435 are illustrated, the network apparatus 400 may have any suitable number of transmitters 430 and receivers 435. Further, the transmitter(s) 430 and the receiver(s) 435 may be any suitable type of transmitters and receivers.

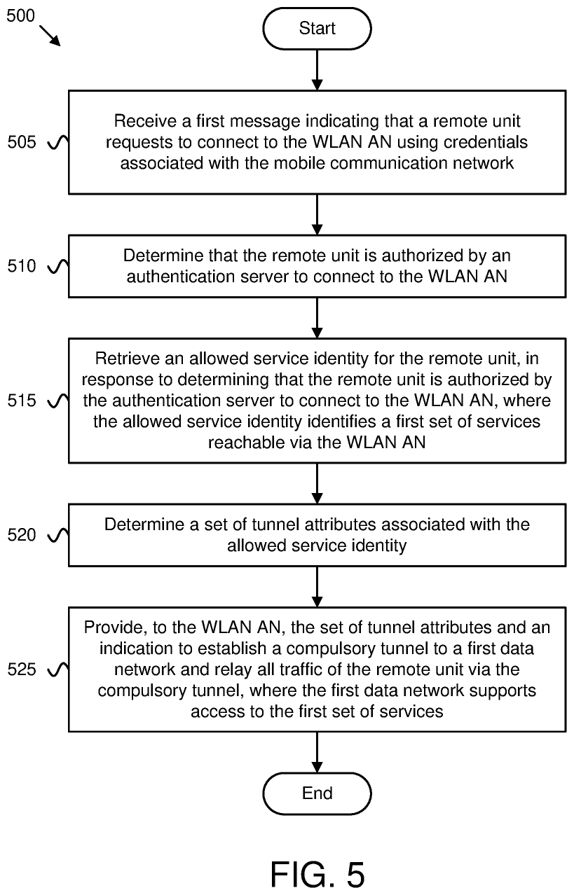

FIG. 5 depicts one embodiment of a method 500 for establishing a compulsory tunnel for NSWO, according to embodiments of the disclosure. In various embodiments, the method 500 is performed by a NSWOF entity, such as the NSWO NF 145, the NSWOF 207, and/or the network apparatus 400, described above as described above. In some embodiments, the method 500 is performed by a processor, such as a microcontroller, a microprocessor, a CPU, a GPU, an auxiliary processing unit, a FPGA, or the like.

The method 500 begins and receives 505 a first message indicating that a remote unit requests to connect to the WLAN AN using credentials associated with the mobile communication network. The method 500 includes determining 510 that the remote unit is authorized by an authentication server to connect to the WLAN AN. The method 500 includes retrieving 515 an allowed service identity for the remote unit, in response to determining that the remote unit is authorized by the authentication server to connect to the WLAN AN, where the allowed service identity identifies a first set of services reachable via the WLAN AN. The method 500 includes determining 520 a set of tunnel attributes associated with the allowed service identity. The method 500 includes providing 525, to the WLAN AN, the set of tunnel attributes and an indication to establish a compulsory tunnel to a first data network and relay all traffic of the remote unit via the compulsory tunnel, where the first data network supports access to the first set of services. The method 500 ends.

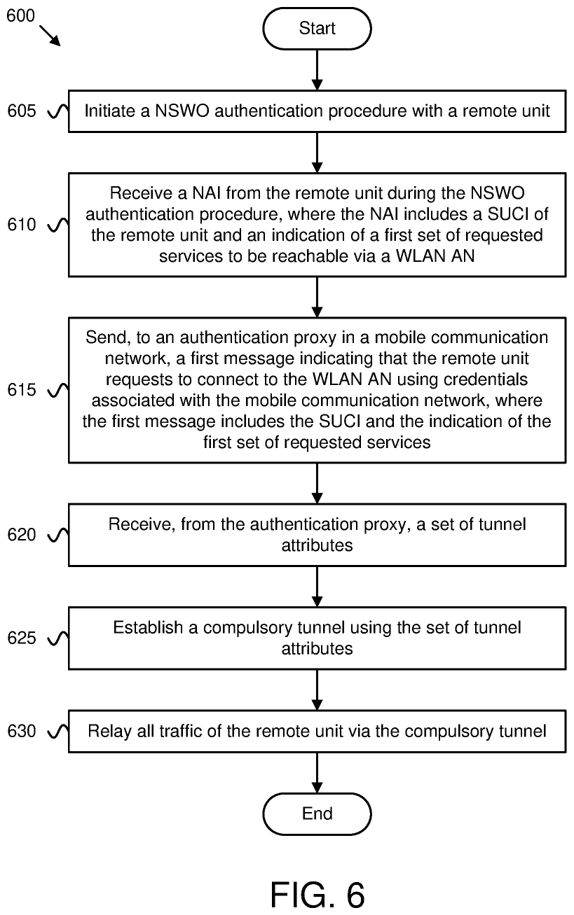

FIG. 6 depicts one embodiment of a method 600 for establishing a compulsory tunnel for NSWO, according to embodiments of the disclosure. In various embodiments, the method 600 is performed by a WLAN AN entity, such as the access point 121, the WLAN AN 203, and/or the network apparatus 400, described above as described above. In some embodiments, the method 600 is performed by a processor, such as a microcontroller, a microprocessor, a CPU, a GPU, an auxiliary processing unit, a FPGA, or the like.

The method 600 begins and initiates 605 a NSWO authentication procedure with a remote unit. The method 600 includes receiving 610 a NAI from the remote unit during the NSWO authentication procedure. Here, the NAI includes a SUCI of the remote unit and an indication of a first set of requested services to be reachable via a WLAN AN. The method 600 includes sending 615, to an authentication proxy in a mobile communication network (e.g., a NSWO NF), a first message indicating that the remote unit requests to connect to the WLAN AN using credentials associated with the mobile communication network, where the first message includes the SUCI and the indication of the first set of requested services. The method 600 includes receiving 620, from the authentication proxy, a set of tunnel attributes. The method 600 includes establishing 625 a compulsory tunnel using the set of tunnel attributes. The method 600 includes relaying 630 all traffic of the remote unit via the compulsory tunnel. The method 600 ends.

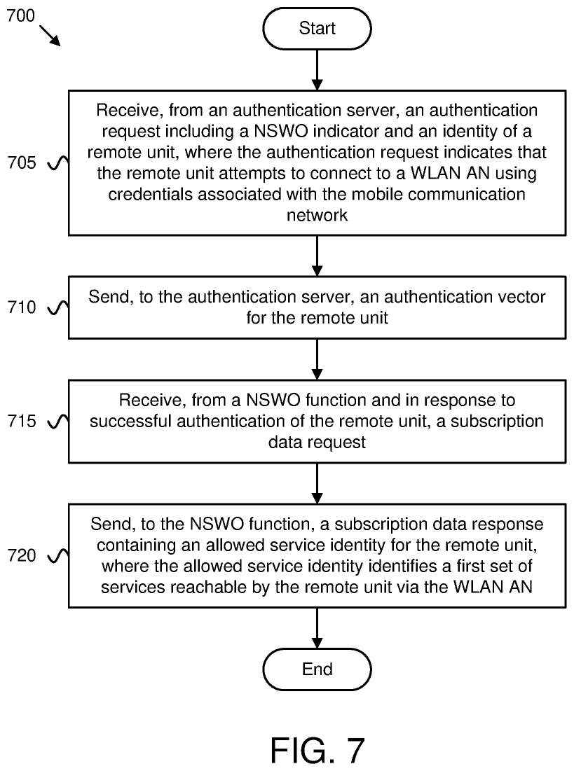

FIG. 7 depicts one embodiment of a method 700 for establishing a compulsory tunnel for NSWO, according to embodiments of the disclosure. In various embodiments, the method 700 is performed by a user data management server in a mobile communication network, such as the UDM/UDR 149, the UDM 211, and/or the network apparatus 400, described above as described above. In some embodiments, the method 700 is performed by a processor, such as a microcontroller, a microprocessor, a CPU, a GPU, an auxiliary processing unit, a FPGA, or the like.

The method 700 begins and receives 705, from an authentication server in a mobile communication network (e.g., an AUSF), an authentication request including a NSWO indicator and an identity of a remote unit. Here, the authentication request indicates that the remote unit attempts to connect to a WLAN AN using credentials associated with the mobile communication network. The method 700 includes sending 710, to the authentication server, an authentication vector for the remote unit. The method 700 includes receiving 715, from a NSWO function and in response to successful authentication of the remote unit, a subscription data request. The method 700 includes sending 720, to the NSWO function, a subscription data response containing an allowed service identity for the remote unit, where the allowed service identity identifies a first set of services reachable by the remote unit via the WLAN AN. The method 700 ends.

Disclosed herein is a first apparatus for establishing a compulsory tunnel for NSWO, according to embodiments of the disclosure. The first apparatus may be implemented by a NSWOF entity, such as the NSWO NF 145, the NSWOF 207, and/or the network apparatus 400, described above. The first apparatus includes a transceiver configured to communicate with a WLAN AN and with one or more network functions in the mobile communication network and a processor coupled to the transceiver, the processor configured to cause the apparatus to: A) receive a first message indicating that a remote unit requests to connect to the WLAN AN using credentials associated with the mobile communication network; B) determine that the remote unit is authorized by an authentication server to connect to the WLAN AN; C) retrieve an allowed service identity for the remote unit, in response to determining that the remote unit is authorized by the authentication server to connect to the WLAN AN, where the allowed service identity identifies a first set of services reachable via the WLAN; D) determine a set of tunnel attributes associated with the allowed service identity; and E) provide, to the WLAN AN, the set of tunnel attributes and an indication to establish a compulsory tunnel to a first data network and relay all traffic of the remote unit via the compulsory tunnel, where the first data network supports access to the first set of services.

In some embodiments, the first message contains a SUCI of the remote unit and an indication of a second set of services to be reachable via the WLAN AN. In some embodiments, to provide the set of tunnel attributes, the processor is configured to send, to the WLAN AN, an access accept message contains the set of tunnel attributes, a success indication, and a session key.

In some embodiments, the first message and the access accept message are SWa protocol messages exchanged during a NSWO authentication procedure.

In some embodiments, to retrieve the allowed service identity, the processor is configured to: A) send, to a UDM in the mobile communication network, a request message containing an access network identifier and a requested service identity, where the requested service identity identifies a second set of services to be reachable via the WLAN AN; and B) receive, from the UDM, a response message containing the allowed service identity.

In some embodiments, to determine the set of tunnel attributes, the processor is configured to: A) send, to a NRF in the mobile communication network, a request message contains the allowed service identity; and B) receive, from the NRF, a response message containing the set of tunnel attributes associated with the allowed service identity. In other embodiments, to determine the set of tunnel attributes, the processor is configured to receive configuration information, wherein the set of tunnel attributes is determined from the allowed service identity, using the received configuration information. In various embodiments, the set of tunnel attributes includes one or more of: A) a tunnel type, B) a tunnel medium type, C) a tunnel client endpoint, D) a tunnel server endpoint, E) a tunnel client authentication identifier, F) a tunnel server authentication identifier, or G) some combination thereof.

Disclosed herein is a first method for establishing a compulsory tunnel for NSWO, according to embodiments of the disclosure. The first method may be performed by a NSWOF entity, such as the NSWO NF 145, the NSWOF 207, and/or the network apparatus 400, described above. The first method includes receiving a first message indicating that a remote unit requests to connect to the WLAN AN using credentials associated with the mobile communication network and determining that the remote unit is authorized by an authentication server to connect to the WLAN AN. The first method includes retrieving an allowed service identity for the remote unit, in response to determining that the remote unit is authorized by the authentication server to connect to the WLAN AN, where the allowed service identity identifies a first set of services reachable via the WLAN. The first method includes determining a set of tunnel attributes associated with the allowed service identity and providing, to the WLAN AN, the set of tunnel attributes and an indication to establish a compulsory tunnel to a first data network and relay all traffic of the remote unit via the compulsory tunnel, where the first data network supports access to the first set of services.

In some embodiments, the first message includes a SUCI of the remote unit and an indication of a second set of services to be reachable via the WLAN AN. In some embodiments, providing the set of tunnel attributes includes sending an access accept message to the WLAN AN, where the access accept message contains the set of tunnel attributes, a success indication, and a session key. In some embodiments, the first message and the access accept message are SWa protocol messages exchanged during a NSWO authentication procedure.

In some embodiments, retrieving the allowed service identity includes sending a request message to a UDM and receiving a response message from the UDM. In such embodiments, the request message may include an access network identifier and a requested service identity, where the requested service identity identifies a second set of services to be reachable via the WLAN AN, and the response message contains the allowed service identity.

In some embodiments, determining the set of tunnel attributes includes sending, to a NRF in the mobile communication network, a request message containing the allowed service identity and receiving, from the NRF, a response message containing the set of tunnel attributes associated with the allowed service identity. In other embodiments, to determine the set of tunnel attributes, the processor is configured to receive configuration information, wherein the set of tunnel attributes is determined from the allowed service identity, using the received configuration information. In various embodiments, the set of tunnel attributes includes one or more of: A) a tunnel type, B) a tunnel medium type, C) a tunnel client endpoint, D) a tunnel server endpoint, E) a tunnel client authentication identifier, F) a tunnel server authentication identifier, or G) some combination thereof.

Disclosed herein is a second apparatus for establishing a compulsory tunnel for NSWO, according to embodiments of the disclosure. The second apparatus may be implemented by an access network entity, such as the access point 121, WLAN NF 203, and/or the network apparatus 400, described above. The second apparatus includes a transceiver configured to communicate with a remote unit and a mobile communication network and a processor coupled to the transceiver, the processor configured to cause the apparatus to: A) initiate a NSWO authentication procedure with the remote unit; B) receive a NAI from the remote unit during the NSWO authentication procedure, where the NAI includes a SUCI of the remote unit and an indication of a first set of requested services to be reachable via an access network (e.g., a WLAN AN containing the second apparatus); C) send, to an authentication proxy in the mobile communication network (e.g., a NSWO NF), a first message indicating that the remote unit requests to connect to the access network using credentials associated with the mobile communication network, where the first message includes the SUCI and the indication of the first set of requested services; D) receive, from the authentication proxy, a set of tunnel attributes; E) establish a compulsory tunnel using the set of tunnel attributes; and F) relay all traffic of the remote unit via the compulsory tunnel.

In some embodiments, to establish the compulsory tunnel, the processor is configured to cause the apparatus to establish the compulsory tunnel with a first data network, where the first data network supports access to an allowed set of services. In various embodiments, the set of tunnel attributes includes one or more of: A) a tunnel type, B) a tunnel medium type, C) a tunnel client endpoint, D) a tunnel server endpoint, E) a tunnel client authentication identifier, F) a tunnel server authentication identifier, or G) some combination thereof.

In some embodiments, to receive the set of tunnel attributes, the processor is configured to receive an access accept message including the set of tunnel attributes, a success indication, and a session key. In some embodiments, the first message and the access accept message are SWa protocol messages exchanged during the NSWO authentication procedure.

Disclosed herein is a second method for establishing a compulsory tunnel for NSWO, according to embodiments of the disclosure. The second method may be performed by an access network entity, such as the access point 121, the AAA proxy 135, the WLAN AN 203, and/or the network apparatus 400, described above. The second method includes initiating a NSWO authentication procedure with a remote unit (e.g., a UE) and receiving a NAI from the remote unit during the NSWO authentication procedure. Here, the NAI includes a SUCI of the remote unit and an indication of a first set of requested services to be reachable via an access network (e.g., the WLAN AN containing the access network entity). The second method includes sending, to an authentication proxy in a mobile communication network (e.g., a NSWO NF), a first message indicating that the remote unit requests to connect to the access network using credentials associated with the mobile communication network, where the first message includes the SUCI and the indication of the first set of requested services. The second method includes receiving, from the authentication proxy, a set of tunnel attributes and establishing a compulsory tunnel using the set of tunnel attributes. The second method includes relaying all traffic of the remote unit via the compulsory tunnel.

In some embodiments, establishing the compulsory tunnel includes establishing the compulsory tunnel with a first data network, where the first data network supports access to an allowed set of services. In various embodiments, the set of tunnel attributes includes one or more of: A) a tunnel type, B) a tunnel medium type, C) a tunnel client endpoint, D) a tunnel server endpoint, E) a tunnel client authentication identifier, F) a tunnel server authentication identifier, or G) some combination thereof.

In some embodiments, receiving the set of tunnel attributes includes receiving an access accept message containing the set of tunnel attributes, a success indication, and a session key. In some embodiments, the first message and the access accept message are SWa protocol messages exchanged during the NSWO authentication procedure.

Disclosed herein is a third apparatus for establishing a compulsory tunnel for NSWO, according to embodiments of the disclosure. The third apparatus may be implemented by a user data management server, such as the UDM/UDR 149, the UDM 211, and/or the network apparatus 400, described above. The third apparatus includes a transceiver configured to communicate with one or more network functions in a mobile communication network and a processor coupled to the transceiver, the processor configured to cause the apparatus to: A) receive, from an authentication server in the mobile communication network (e.g., an AUSF), an authentication request including a NSWO indicator and an identity of a remote unit, where the authentication request indicates that the remote unit attempts to connect to a WLAN using credentials associated with the mobile communication network; B) send, to the authentication server, an authentication vector for the remote unit; C) receive, from a NSWO function and in response to successful authentication of the remote unit, a subscription data request; and D) send, to the NSWO function (e.g., the NSWOF 145 and/or the NSWOF 207), a subscription data response containing an allowed service identity for the remote unit, where the allowed service identity identifies a first set of services reachable by the remote unit via the WLAN.

In some embodiments, the subscription data request message includes a SUPI of the remote unit and a requested service identity identifying a second set of services to be reachable via the WLAN. In some embodiments, the allowed service identity is determined using: A) configuration information, B) subscription data corresponding to the remote unit, C) an access network identity of the WLAN, D) a requested service identity, or E) some combination thereof.

Disclosed herein is a third method for establishing a compulsory tunnel for NSWO, according to embodiments of the disclosure. The third method may be performed by a network function, such as the UDM/UDR 149, the UDM 211, and/or the network apparatus 400, described above. The third method includes receiving, from an authentication server in a mobile communication network (e.g., an AUSF), an authentication request including a NSWO indicator and an identity of a remote unit. Here, the authentication request indicates that the remote unit attempts to connect to a WLAN using credentials associated with the mobile communication network. The third method includes sending, to the authentication server, an authentication vector for the remote unit and, in response to successful authentication of the remote unit, receiving a subscription data request from a NSWO function. The third method includes sending, to the NSWO function, a subscription data response containing an allowed service identity for the remote unit, where the allowed service identity identifies a first set of services reachable by the remote unit via the WLAN.

In some embodiments, the subscription data request message includes a SUPI of the remote unit and a requested service identity identifying a second set of services to be reachable via the WLAN. In some embodiments, the allowed service identity is determined using: A) configuration information, B) subscription data corresponding to the remote unit, C) an access network identity of the WLAN, D) a requested service identity, or E) some combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A network apparatus comprising:
a memory; and
a processor coupled with the memory and configured to cause the network apparatus to:
receive a first message indicating that a user equipment (“UE”) requests to connect to a wireless local access network (“WLAN”) access network using credentials associated with a mobile communication network;
determine that the UE is authorized by an authentication server in the mobile communication network to connect to the WLAN access network;
determine, in response to the UE being authorized by the authentication server to connect to the WLAN access network, a set of tunnel attributes associated with the UE; and
provide, to the WLAN access network, the set of tunnel attributes and an indication to establish a tunnel to a first data network and relay all traffic of the UE via the tunnel.

2. The network apparatus of claim 1, wherein the first message comprises a subscriber concealed identity (“SUCI”) of the UE and an indication of a second set of services to be reachable via the WLAN access network.

3. The network apparatus of claim 1, wherein, the processor is configured to:
transmit, to a Unified Data Management function (“UDM”) in the mobile communication network, a request message comprising an access network identifier and a requested service identity, wherein the requested service identity identifies a second set of services to be reachable via the WLAN access network; and
receive, from the UDM, a response message containing an allowed service identity.

4. The network apparatus of claim 1, wherein, to determine the set of tunnel attributes, the processor is configured to:
transmit, to a Network Repository Function (“NRF”) in the mobile communication network, a request message comprising an allowed service identity; and
receive, from the NRF, a response message containing the set of tunnel attributes associated with the allowed service identity,
wherein the set of tunnel attributes comprises:
a tunnel type,
a tunnel medium type,
a tunnel client endpoint,
a tunnel server endpoint,
a tunnel client authentication identifier,
a tunnel server authentication identifier,
or combinations thereof.

5. The network apparatus of claim 1, wherein, to determine the set of tunnel attributes, the processor is configured to:
receive configuration information, wherein the set of tunnel attributes is determined from an allowed service identity, using the received configuration information,
wherein the set of tunnel attributes comprises:
a tunnel type,
a tunnel medium type,
a tunnel client endpoint,
a tunnel server endpoint,
a tunnel client authentication identifier,
a tunnel server authentication identifier,
or combinations thereof.

6. The network apparatus of claim 1, wherein, to provide the set of tunnel attributes, the processor is configured to:
transmit, to the WLAN access network, an access accept message comprising the set of tunnel attributes, a success indication, and a session key,
wherein the first message and the access accept message are SWa protocol messages exchanged during a Non-Seamless WLAN Offloading (“NSWO”) authentication procedure.

7. An apparatus in an access network, the apparatus comprising:
a memory; and
a processor coupled with the memory and configured to cause the apparatus to:
initiate a Non-Seamless WLAN Offloading (“NSWO”) authentication procedure with a user equipment (“UE”);
receive a network access identifier from the UE during the NSWO authentication procedure, wherein the network access identifier comprises a subscriber concealed identity (“SUCI”) of the UE and an indication of a first set of requested services to be reachable via the access network;
transmit, to an authentication proxy in a mobile communication network, a first message indicating that the UE requests to connect to the access network using credentials associated with the mobile communication network, wherein the first message comprises the SUCI and the indication of the first set of requested services;
receive, from the authentication proxy, a set of tunnel attributes;
establish a compulsory tunnel using the set of tunnel attributes; and
relay all traffic of the UE via the compulsory tunnel.

8. The apparatus of claim 7,
wherein, to establish the compulsory tunnel, the processor is configured to cause the apparatus to establish the compulsory tunnel with a first data network,
wherein the first data network supports access to an allowed set of services.
wherein the set of tunnel attributes comprises:
a tunnel type,
a tunnel medium type,
a tunnel client endpoint,
a tunnel server endpoint,
a tunnel client authentication identifier,
a tunnel server authentication identifier,
or combinations thereof.

9. The apparatus of claim 7, wherein, to receive the set of tunnel attributes, the processor is configured to:
receive an access accept message comprising the set of tunnel attributes, a success indication, and a session key,
wherein the first message and the access accept message are SWa protocol messages exchanged during the NSWO authentication procedure.

10. A network apparatus comprising:
a memory; and
a processor coupled with the memory and configured to cause the network apparatus to:
receive, from an authentication server in a mobile communication network, an authentication request comprising a Non-Seamless Wireless local area network Offloading (“NSWO”) indicator and an identity of a user equipment (“UE”), wherein the authentication request indicates an attempt by the UE to connect to a Wireless Local Area Network (“WLAN”) using credentials associated with the mobile communication network;
transmit, to the authentication server, an authentication vector for the UE;
receive, from a NSWO function and in response to successful authentication of the UE, a subscription data request; and
transmit, to the NSWO function, a subscription data response indicating a first set of services reachable by the UE via the WLAN.

11. The network apparatus of claim 10, wherein the subscription data request comprises a subscriber permanent identity (“SUPI”) of the UE and a requested service identity identifying a second set of services to be reachable via the WLAN.

12. The network apparatus of claim 10, wherein the subscription data comprises an allowed service identity for the UE, and wherein the allowed service identity is based on:
configuration information,
subscription data corresponding to the UE,
an access network identity of the WLAN,
a requested service identity,
or combinations thereof.

13. The network apparatus of claim 1, wherein the processor is configured to cause the network apparatus to retrieve an allowed service identity for the UE, in response to determining that the UE is authorized by the authentication server to connect to the WLAN access network, wherein the allowed service identity identifies a first set of services reachable via the WLAN.

14. A method performed by a network apparatus, the method comprising:
receiving a first message indicating that a user equipment (“UE”) requests to connect to a wireless local area network (“WLAN”) access network using credentials associated with a mobile communication network;
determining that the UE is authorized by an authentication server to connect to the WLAN access network;
determining a set of tunnel attributes associated with the UE, in response to the UE being authorized by the authentication server to connect to the WLAN access network; and
providing, to the WLAN access network, the set of tunnel attributes and an indication to establish a compulsory tunnel to a first data network and relay all traffic of the UE via the compulsory tunnel.

15. The method of claim 14, wherein the first message comprises a subscriber concealed identity (“SUCI”) of the UE and an indication of a second set of services to be reachable via the WLAN access network.

16. The method of claim 14, further comprising retrieving an allowed service identity for the UE, in response to determining that the UE is authorized by the authentication server to connect to the WLAN access network, wherein the allowed service identity identifies a first set of services reachable via the WLAN.

17. The method of claim 16 wherein retrieving the allowed service identity comprises:
transmit, to a Unified Data Management function (“UDM”) in the mobile communication network, a request message comprising an access network identifier and a requested service identity, wherein the requested service identity identifies a second set of services to be reachable via the WLAN access network; and
receive, from the UDM, a response message containing the allowed service identity.

18. The method of claim 16, wherein determining the set of tunnel attributes comprises:
transmitting, to a Network Repository Function (“NRF”) in the mobile communication network, a request message comprising the allowed service identity; and
receiving, from the NRF, a response message containing the set of tunnel attributes associated with the allowed service identity,
wherein the set of tunnel attributes comprises:
a tunnel type,
a tunnel medium type,
a tunnel client endpoint,
a tunnel server endpoint,
a tunnel client authentication identifier,
a tunnel server authentication identifier,
or combinations thereof.

19. The method of claim 16, wherein determining the set of tunnel attributes comprises:
receiving configuration information, wherein the set of tunnel attributes is determined from the allowed service identity, using the received configuration information,
wherein the set of tunnel attributes comprises:
a tunnel type,
a tunnel medium type,
a tunnel client endpoint,
a tunnel server endpoint,
a tunnel client authentication identifier,
a tunnel server authentication identifier,
or combinations thereof.

20. The method of claim 14, wherein providing the set of tunnel attributes comprises:
transmitting, to the WLAN access network, an access accept message comprising the set of tunnel attributes, a success indication, and a session key,
wherein the first message and the access accept message are SWa protocol messages exchanged during a Non-Seamless WLAN Offloading (“NSWO”) authentication procedure.
